(19) United States
(12) Patent Application Publication
(10) Pub. No.: US 2020/0132103 A1
(43) Pub. Date: Apr. 30, 2020

(54) SCREW STRUCTURE

(71) Applicant: YU-TENG HSIAO, CHIAYI CITY (TW)

(72) Inventor: YU-TENG HSIAO, CHIAYI CITY (TW)

(21) Appl. No.: 16/173,262

(22) Filed: Oct. 29, 2018

(51) Int. Cl. F16B 33/06; F16B 39/02; F16B 33/00

(52) U.S. Cl. CPC F16B 33/06; F16B 2001/0035; F16B 33/002; F16B 39/02

(57) ABSTRACT

A screw structure is disclosed herein. It comprises a fastening member having a thread part and a magnetic layer formed on a surface of the thread part.

### BACKGROUND OF THE INVENTION

### 1. Field of the Invention

The present invention relates to provide a screw structure which can rapidly and firmly lock an object by magnetic attraction of a magnetic layer on a surface of a thread part so as to achieve effects of anti-loose and increasing practicality in its overall application.

### 2. Description of Related Art

The combination of screws and bolt nuts is widely used in various industries such as machinery, electronics, motors, transportation, electrical appliances, furniture, construction and the like for locking and bonding different components. With the development of the industry, the use of screws and bolt nuts has also increased. Obviously, screws and bolt nuts play important roles in the industrial market.

Although the abovementioned combination of the screws and bolt nuts achieves the expected effects of screwing and assembling components, it has many disadvantages in practical use that need to be solved. For instance, even if the screw is screwed onto the bolt nut, they may easily loosen from each other due to external force, e.g. vibration and the like, after they are used for a long time, which may cause looseness and instability between the components that are screwed together.

### SUMMARY OF THE INVENTION

In view of the above-mentioned problems, the object of the present invention is to provide a screw structure which has a magnetic layer on a surface of a thread part so as to rapidly and firmly lock an object by magnetic attraction and achieve effects of anti-loose and increasing practicality in its overall application.

Disclosed herein is a screw structure. It mainly comprises a fastening member having a thread part and a magnetic layer formed on a surface of the thread part.

According to an embodiment of the present invention, the fastening member is a screw.

According to an embodiment of the present invention, the fastening member is a bolt nut.

According to an embodiment of the present invention, the magnetic layer is made of a magnetic coating.

### BRIEF DESCRIPTION OF THE DRAWINGS

FIG. 1 is a stereogram showing a first embodiment for a screw structure according to the present invention;

FIG. 2 is a stereogram showing a second embodiment for a screw structure according to the present invention;

FIG. 3 is a cross-sectional view showing the first embodiment for the screw structure according to the present invention;

FIG. 4 is a partial enlarged cross-sectional view showing the first embodiment for the screw structure according to the present invention;

FIG. 5 is a cross-sectional view showing the second embodiment for the screw structure according to the present invention.

### DETAILED DESCRIPTION OF THE PREFERRED EMBODIMENT

Hereinafter, an exemplary embodiment of the present invention will be described in detail with reference to the accompanying drawings.

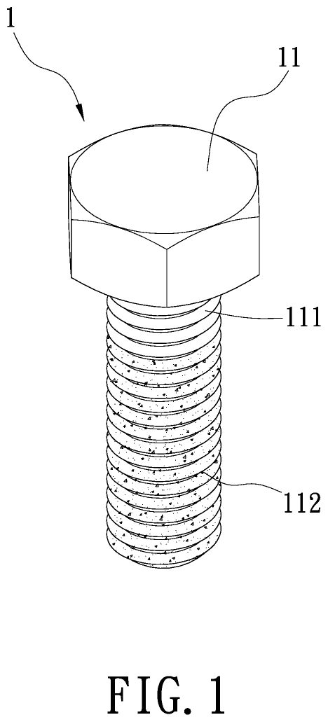

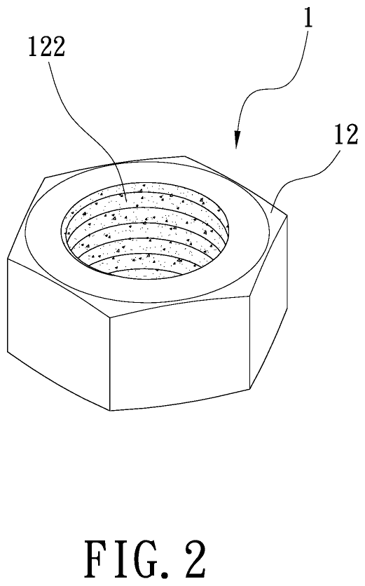

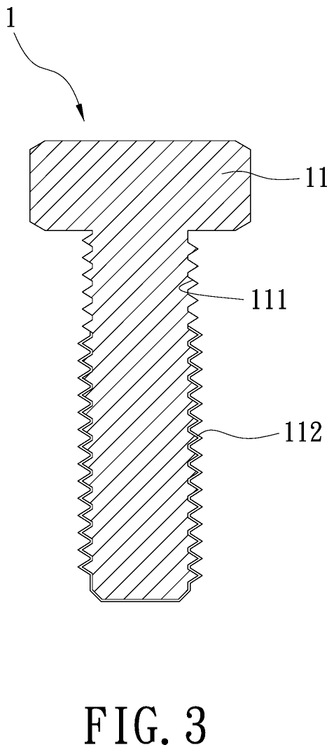

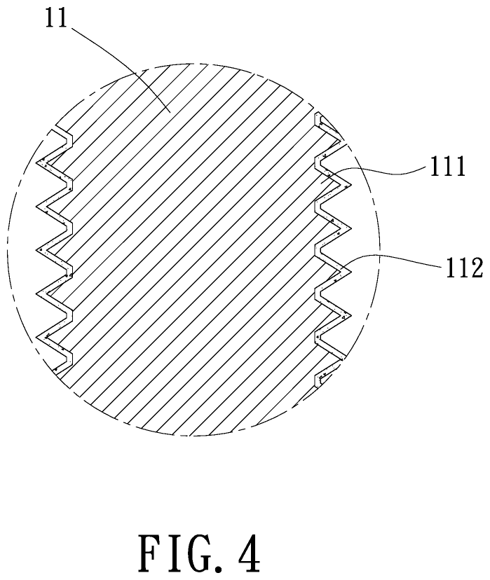

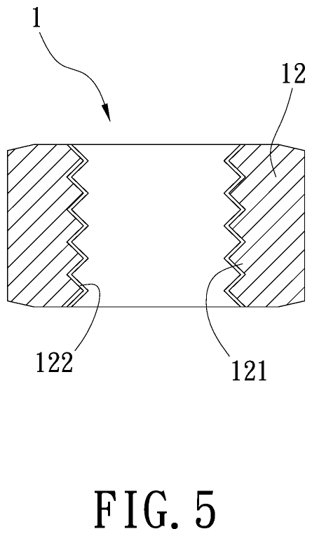

As showed in FIG. 1 and FIG. 2, a stereogram showing a first embodiment for a screw structure and a second embodiment for a screw structure according to the present invention are respectively disclosed herein. The screw structure mainly comprises a fastening member (1). The fastening member (1) is a screw (11) or a bolt nut (12) and has a thread part (111) (121) and a magnetic layer (112) (122) formed on a surface of the thread part (111) (121) as shown in FIG. 3, FIG. 4 and FIG. 5. The magnetic layer (112) (122) is made of a magnetic coating.

In use of the present invention that the fastening member (1) is the screw (11), the screw (11) is screwed to a general bolt nut by the magnetic layer (112) formed on the thread part (111). The magnetic layer (112) makes the screw (11) stably assembled to the general bolt nut by magnetic attraction so that the effect of anti-loose is achieved. In use of the present invention that the fastening member (1) is the bolt nut (12), the bolt nut (12) is screwed to a general screw by the magnetic layer (122) formed on the thread part (121). The magnetic layer (122) makes the bolt nut (12) stably assembled to the general screw by magnetic attraction so that the effect of anti-loose is achieved.

Accordingly, compared with the technique available now, the present invention has the magnetic layer on the surface of the thread part so it can rapidly and firmly lock an object by magnetic attraction and achieve effects of anti-loose and increasing practicality in its overall application.

What is claimed is:

1. A screw structure, comprising a fastening member having a thread part and a magnetic layer formed on a surface of the thread part.

2. The screw structure as claimed in claim 1, wherein the fastening member is a screw.

3. The screw structure as claimed in claim 1, wherein the fastening member is a bolt nut.

4. The screw structure as claimed in claim 1, wherein the magnetic layer is made of a magnetic coating.
